(19) United States
(12) Patent Application Publication
(10) Pub. No.: US 2024/0210034 A1
(43) Pub. Date: Jun. 27, 2024

(54) CERAMIC GLOW PLUG

(71) Applicant: CHONGQING LE-MARK TECHNOLOGY CO., LTD., Chongqing (CN)

(72) Inventor: Peter LEIGH, Chongqing (CN)

(21) Appl. No.: 18/557,424

(22) PCT Filed: Sep. 16, 2022
(86) PCT No.: PCT/CN2022/119173

§ 371 Date: Oct. 26, 2023

(30) Foreign Application Priority Data
Sep. 29, 2021 (CN) 202111147600.7

(51) Int. Cl. F23Q 7/00; F02P 19/02

(52) U.S. Cl. CPC F23Q 7/001; F02P 19/02

(57) ABSTRACT

The present application relates to the technical field of electric heating devices for engines. Disclosed is a ceramic glow plug, comprising a housing and a heating element, the heating element being provided inside the housing, and a positive wire being connected to the top of the heating element, wherein the housing comprises an upper housing and a lower housing, both the positive wire and a negative wire pass through the upper housing, and the negative wire is connected to the heating element. The ceramic glow plug has the advantage of being resistant to electromagnetic interference.

### CROSS-REFERENCE TO RELATED APPLICATIONS

This application is a national stage entry application under 35 U.S.C. 371 of PCT Patent Application No. PCT/CN2022/119173, filed on Sep. 9, 2022, which claims priority to Chinese Patent Application No. 202111147600.7 filed on Sep. 29, 2021, the entire contents of each of which are incorporated herein by reference.

### TECHNICAL FIELD

The present disclosure relates to the technical field of electric heating devices for engines, and in particular, to a ceramic glow plug.

### BACKGROUND

A glow plug of a conventional diesel engine or combustor has a single-wire structure, in which a metal housing to which an apparatus body is connected is connected to a negative electrode of a power supply to form a loop. For example, the patent with the application no. CN96230894.3 discloses a ceramic glow plug, comprising a housing, a metal cap, a heating wire, and a heating element, wherein the wire is connected to the metal cap, and forms a loop with the housing to electrify the heating element. As another example, the patent with the application no. U.S. Pat. No. 5,880,432 A discloses a ceramic heater having a single-wire structure in which a loop is formed by making a housing conductive, so as to cause a ceramic heater to generate heat. The single-wire structures in the prior art are susceptible to electromagnetic field interference, which affects the operation of a glow plug.

### SUMMARY

An object of the present disclosure is to provide a ceramic glow plug to solve the problem of electromagnetic interference.

In order to achieve the described object, the present disclosure, in an embodiment, employs the following technical solution.

A ceramic glow plug, comprising a housing and a heating element, the heating element being provided inside the housing, a positive wire being connected to the top of the heating element, wherein the housing comprises an upper housing and a lower housing, both the positive wire and a negative wire pass through the upper housing, and the negative wire is connected to the heating element.

In order to facilitate the connection of the negative wire to the heating element, an opening may be provided on the lower housing.

Further, the opening may be provided on the top of the lower housing.

Further, the negative wire may pass through the opening and be in conductive connection with the middle portion of the heating element.

In order to secure the heating element while avoiding interference due to contact between the negative wire and the housing, an insulating layer may be provided between the heating element and the lower housing.

Further, an insulating layer may be provided between the heating element and the upper housing.

Further, a gap between the heating element and the upper housing may be filled with an insulating material.

In order to maintain the overall appearance intact, the lower housing may be in fit connection with the upper housing, and the upper housing covers the opening of the lower housing.

Beneficial effects: the present disclosure provides a ceramic glow plug, which solves the problem of electromagnetic interference with electrodes. Electromagnetic interference is any electronic noise generated in conduction or by the effect of an electromagnetic field accompanied by voltage or current, which degrades the performance of a device, apparatus or system. A double-wire structure is used, a positive electrode and a negative electrode are completely isolated from the housing, and a circuit to be protected is covered by the housing, effectively preventing the interference of an electric field or a magnetic field; meanwhile, the electrification of two electrodes prevents short-circuiting, and components such as a terminal block and an insulating ring of a single-wire structure are eliminated, making the structure simpler.

### BRIEF DESCRIPTION OF THE DRAWINGS

FIG. 1 is a sectional view of a ceramic glow plug in embodiment 1.

FIG. 2 is a three-dimensional schematic view of the ceramic glow plug.

FIG. 3 is a structural schematic view of a lower housing.

FIG. 4 is a sectional view of an upper housing.

Reference numbers: 1. lower housing; 2. heating element; 3. upper housing; 4: negative wire; 5. positive wire; 6: opening.

### DETAILED DESCRIPTION OF THE EMBODIMENTS

The present disclosure will be further described with reference to the accompanying drawings and specific embodiments. However, the description of the following embodiments serves only to aid in understanding the principle and core idea of the present disclosure and is not intended to limit the scope of protection of the present disclosure. It should be noted that, for a person skilled in the art, improvements made to the present disclosure without departing from the principle of the present invention also fall within the scope of protection of the present disclosure.

### EMBODIMENT

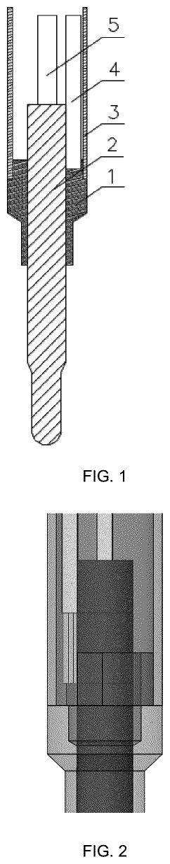

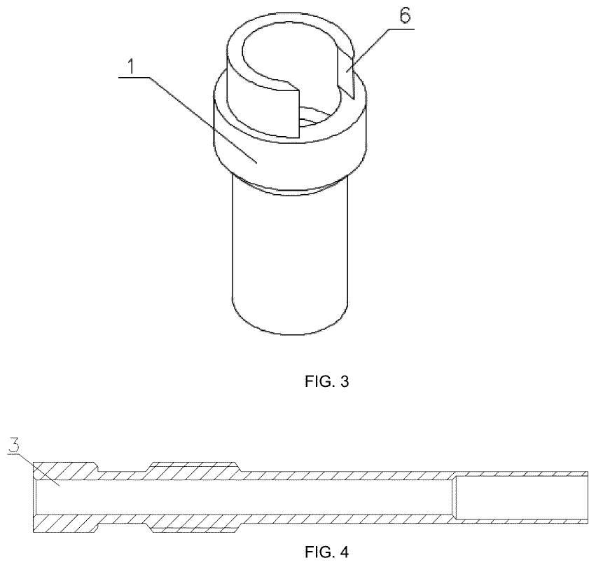

As shown in FIGS. 1, 2, 3, and 4, a ceramic glow plug comprises a housing and a heating element 2, the heating element 2 being provided inside the housing; the housing comprises an upper housing 3 and a lower housing 1; a positive wire 5 and a negative wire 4 are introduced from above the upper housing 3, and the upper housing 3 covers both the positive wire 5 and the negative wire 4 at the same time; the positive wire 5 is connected to the top of the heating element 2 and the negative wire 4 is connected to the middle portion of the heating element 2; and when electrified, the positive and negative wires form a loop with the heating element 2 so as to rapidly raise the temperature of the heating element 2.

An opening 6 is provided at the top of the lower housing 1; the negative wire 4 passes through the opening 6 and is soldered to the middle portion of the heating element 2; the opening 6 provides a channel for allowing the connection between the negative wire 4 and the heating element 2; when soldering is performed, a high temperature is generated to melt the negative wire 4 so that the negative wire and the heating element 2 are connected together and a solder joint is formed; the opening 6 provides a space for accommodating the solder joint generated when the negative wire 4 is soldered onto the heating element 2; the stronger the soldering, the more stable the electrical conductivity of the negative wire; and a terminal block of a conventional single-wire structure is replaced, making the structure simpler.

In the casting process, a ceramic insulating layer is provided between the heating element 2 and the upper housing 3 and the lower housing 1; the ceramic insulating layers can connect the heating element 2 with the upper housing 3 and the lower housing 1, and also achieve the effect of isolating and not conducting electricity; a gap between the heating element 2 and the upper housing 3 is filled with an insulating ceramic gel material; and the ceramic gel material is gradually cured when heated and is used to isolate the heating element 2 from the upper housing 3 and, at the same time, to wrap the positive and negative wires to protect the wires.

The opening is fittingly connected to the upper housing 3, and an interface of the upper housing 3 covers the opening 6, so that the overall appearance remains intact.

In the severe cold period when a diesel engine cools down, the ceramic glow plug is screwed into the wall of each combustion chamber of the engine; the ceramic glow plug provides heat to improve the starting performance; meanwhile, the ceramic glow plug is required to have the characteristics of being heated rapidly and maintaining a continuous high-temperature state; before the engine is started, a low-voltage power supply is connected to the positive and negative wires, and when a current flows through the heating element 2, the heating element 2 is in a red and heated state, a combustible mixed gas entering a cylinder is compressed as the piston rises, then the temperature rises thereafter; the heat of the ceramic glow plug reaches a spontaneous ignition point of the mixed gas so that the mixed gas starts to combust and generates a high-temperature and high-pressure gas to push the piston to work.

1. A ceramic glow plug, comprising a housing and a heating element (2), the heating element (2) being provided inside the housing, a positive wire (5) being connected to the top of the heating element (2), wherein the housing comprises an upper housing (3) and a lower housing (1), both the positive wire (5) and a negative wire (4) pass through the upper housing (3), and the negative electrode wire (4) is connected to the heating element (2).

2. The ceramic glow plug according to claim 1, wherein an opening (6) is provided on the lower housing (1).

3. The ceramic glow plug according to claim 2, wherein the opening (6) is provided on the top of the lower housing (1).

4. The ceramic glow plug according to claim 3, wherein the negative wire (4) passes through the opening (6) and is in conductive connection with the middle portion of the heating element (2).

5. The ceramic glow plug according to claim 4 wherein an insulating layer is provided between the heating element (2) and the lower housing (1).

6. The ceramic glow plug according to claim 5, wherein an insulating layer is provided between the heating element (2) and the upper housing (3).

7. The ceramic glow plug according to claim 1, wherein a gap between the heating element (2) and the upper housing (3) is filled with an insulating material.

8. The ceramic glow plug according to claim 2, wherein the upper housing (3) covers the opening (6).

9. The ceramic glow plug according to claim 3, wherein the upper housing (3) covers the opening (6).

10. The ceramic glow plug according to claim 1 wherein an insulating layer is provided between the heating element (2) and the lower housing (1).

11. The ceramic glow plug according to claim 10, wherein an insulating layer is provided between the heating element (2) and the upper housing (3).
